(19) United States
(12) Patent Application Publication
(10) Pub. No.: US 2012/0234846 A1
(43) Pub. Date: Sep. 20, 2012

(54) COLLAPSIBLE CORRUGATED BEVERAGE SLEEVE

(76) Inventor: Donn J. Costanzo, JR., Fort Mill, SC (US)

(21) Appl. No.: 13/420,367

(22) Filed: Mar. 14, 2012

Related U.S. Application Data
(60) Provisional application No. 61/452,640, filed on Mar. 14, 2011.

(51) Int. Cl. B65D 25/00; B31B 1/26; B65D 5/00

(52) U.S. Cl. 220/738; 229/100; 493/405

(57) ABSTRACT

A collapsible beverage sleeve includes a single sheet of material having a bottom section defining a bottom of the beverage sleeve when the blank is folded into a use configuration; and a plurality of side sections defining sides of the beverage sleeve when the blank is a use configuration. The plurality of side sections are defined by one or more first fold lines extending therebetween and comprise: a first end side section; a second end side section; a plurality of standard length side sections, an extended length side section subdivided by second fold lines into a side portion, a hinge portion, and a bottom attachment portion; and a shortened length side section integrally connected by way of a third fold line with the bottom section. The second fold lines extend generally parallel to each other and extending orthogonally to the first fold lines.

### CROSS-REFERENCE TO RELATED APPLICATION

The present application is a nonprovisional patent application of, and claims priority under 35 U.S.C. §119(e) to, U.S. provisional patent application Ser. No. 61/452,640, filed Mar. 14, 2011, which '640 application is incorporated herein by reference. Furthermore, the appendix hereto includes the disclosure of the '640 application relevant to the present application, which disclosure of the appendix is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to containers and, more particularly, to collapsible beverage sleeves, holders, or koozie. Various types of insulating jackets and sleeves have been developed for the purposes of keeping various beverage containers hot or cold as well as acting as a barrier between a user and moisture that forms on the outside of the beverage container. Sleeves, such as the one disclosed in Carlson, U.S. Pat. No. 5,222,656, are intended for insulating a user's hand while holding a beverage cup. Other beverage container holders, such as those disclosed by Henderson, U.S. Pat. No. 4,648,525, and McGough, U.S. Pat. No. 4,293,015, are constructed of collapsible materials to allow for a high degree of portability.

A need exists for improvement in collapsible beverage sleeves. This, and other needs, are addressed by one or more aspects of the present invention.

### SUMMARY OF THE INVENTION

The present invention includes many aspects and features. Moreover, while many aspects and features relate to, and are described in, the context of collapsible beverage sleeves, the present invention is not limited to use only in collapsible beverage sleeves, as will become apparent from the following summaries and detailed descriptions of aspects, features, and one or more embodiments of the present invention. For example, embodiments of the present invention may be used as general containers themselves, rather than as sleeves for beverage containers.

Accordingly, an aspect of the present invention relates to collapsible beverage sleeve as substantially shown and described. An exemplary such collapsible beverage sleeve includes a single sheet of corrugated material. Furthermore, in this aspect of the invention, the collapsible beverage sleeve is capable of transitioning between a use configuration and a collapsed configuration. In the use configuration the collapsible beverage sleeve is adapted to house a beverage container and in the collapsed configuration the collapsible beverage sleeve is collapsed in position.

In a feature of this aspect of the invention, the collapsible beverage sleeve further includes a decorative element applied to an exterior surface of the single sheet of corrugated material. In a variation of this feature, the decorative element includes promotional material. In another variation, the decorative element is an independent element applied to the exterior surface of the single sheet of corrugated material using adhesives. In yet another variation, the decorative element is directly applied to the exterior surface of the single sheet of corrugated material.

In yet another feature, the single sheet of corrugated material includes a plurality of fold lines, the plurality of fold lines defining a base, a first end segment, a second end segment, a plurality of interior segments, and a base attachment segment.

In a variation of this feature, the base attachment segment includes a first end integral with one interior segment of the plurality of interior segments, and a second end attached to the base. In yet another variation, the second end of the base attachment segment is attached to the base using an adhesive material. In still another variation, an exterior surface of the first end segment is attached to an interior surface of the second end segment with an adhesive material.

Another aspect of the invention relates to a collapsible beverage sleeve as substantially shown and described. An exemplary such collapsible beverage sleeve includes a single sheet of corrugated material, including a plurality of fold lines. The plurality of fold lines define a plurality of circumferential segments, a base, a first extension segment, and a second extension segment. Furthermore, the plurality of circumference segments include a first end segment, a second end segment, and a plurality of interior segments. Also, an interior surface of the first end segment is attached to an exterior surface of the second end segment so as to create an interior space resembling an open cylinder, defined by the plurality of circumferential segments and the base. The base is integral with a first interior segment of the plurality of interior segments. The first extension segment includes a distal end and a proximal end, the proximal end of the first extension segment being integral with a second interior segment of the plurality of interior segments, and the distal end of the first extension segment being integral with the second extension segment. Finally, a surface of the second extension segment is attached to a surface of the base.

In a feature of this aspect of the invention, the collapsible beverage sleeve is capable of transitioning between a use configuration, wherein the volume of the interior space is maximized, and a collapsed configuration, wherein the volume of the interior space is minimized.

In an aspect of the present invention that does relate specifically to a method of using a collapsible beverage sleeve. An exemplary such method includes providing a collapsible beverage sleeve comprising a single sheet of corrugated material, including fold lines defining a plurality of adjacent side segments and a base, the plurality of adjacent side segments comprising a first end segment, a plurality of interior segments, and a second end segment, and the first end segment and second end segment are attached in overlapping relation to one another to form a single peripheral surface. Furthermore, manually adjusting the single peripheral surface to maximize the volume of an interior space defined by the peripheral, positioning the base orthogonal to the single peripheral surface, and placing a beverage container within the interior space.

In a feature of this aspect of the invention, the method further includes removing the beverage container from the interior space; applying pressure to the base, opposite the interior space, so as to cause the base to fold inward toward the interior space; and collapsing the single peripheral surface so as to minimize the volume of the interior space.

Another aspect of the present invention relates to a method of assembling a collapsible beverage sleeve. An exemplary such method includes providing a collapsible beverage sleeve comprising a single sheet of corrugated material, including fold lines defining a plurality of adjacent side segments, including a first end segment, a plurality of interior segments, and a second end segment, one segment in the plurality of interior segments including an extension, and a base; attaching an interior face of the first end segment to the exterior face of the second end segment to form a single peripheral surface; and attaching an exterior face of the extension to an exterior face of the base.

A feature of this aspect of the invention, further includes affixing a decorative element to an exterior face of the single sheet of corrugated material.

In another aspect of the invention, a blank for making a collapsible beverage sleeve comprises a single sheet of material. The single sheet of material includes: a bottom section defining a bottom of the beverage sleeve when the blank is folded into a use configuration; and a plurality of side sections defining sides of the beverage sleeve when the blank is a use configuration. The plurality of side sections are defined by one or more first fold lines extending therebetween and comprise: a first end side section; a second end side section; a plurality of standard length side sections, an extended length side section subdivided by second fold lines into a side portion, a hinge portion, and a bottom attachment portion; and a shortened length side section integrally connected by way of a third fold line with the bottom section. The second fold lines extend generally parallel to each other and extending orthogonally to the first fold lines.

Moreover, the bottom section and plurality of side sections are dimensioned and arranged such that the single sheet of material is foldable along with first fold lines, second fold lines, and third fold line into a use configuration of the beverage sleeve, with the first and second end side sections abutting one another, with the bottom attachment portion abutting the bottom section, and with the hinge portion extending between and interconnecting the bottom section and the side portion such that the beverage sleeve is transitionable between the use configuration and a collapsed configuration when the end side section are attached to one another and the bottom attachment portion is attached to the bottom section.

In a feature of this aspect, the single sheet of material comprises a generally planar sheet of corrugated material.

In a feature of this aspect, in the use configuration, the collapsible beverage sleeve is adapted to house a beverage container.

In a feature of this aspect, in the collapsed configuration, half of the interior sides of the side sections forming interior side surfaces of the beverage sleeve extend adjacent and in opposed facing relation to the other half of the interior sides of the side sections forming interior side surfaces of the beverage sleeve.

In a feature of this aspect, the blank further comprises a decorative element applied to an exterior surface of the single sheet of material. The decorative element may be adhered to a surface of the single sheet of material using adhesives, or alternatively, the decorative element may be printed directly on a surface of the single sheet of material.

In another feature, a first side of the single sheet of material, when folded, defines the interior side surfaces of the beverage sleeve and the opposite, second side of the single sheet of material defines the exterior side surfaces of the beverage sleeve.

In another feature, the first side of the single sheet of material when folded into the use configuration further defines the interior bottom surface of the beverage sleeve, and the opposite, seconds side of the single sheet of material defines the exterior bottom surface of the beverage sleeve.

In another aspect of the invention, a collapsible beverage sleeve comprising a single sheet of material. The single sheet comprising: a bottom section defining a bottom of the beverage sleeve; and a plurality of side sections defining sides of the beverage sleeve. The plurality of side sections being defined by one or more first fold lines extending therebetween and comprise: a first end side section; a second end side section; a plurality of standard length side sections; an extended length side section subdivided by second fold lines into a side portion, a hinge portion, and a bottom attachment portion; and a shortened length side section integrally connected by way of a third fold line with the bottom section. The first and second end side sections are attached to one another such that the plurality of side sections completely surrounds an interior space of the beverage sleeve. The bottom attachment portion and bottom section are attached to one another, with the hinge portion extending between and interconnecting the bottom section and the side portion. The beverage sleeve is transitionable between a use configuration and a collapsed configuration by folding about the fold lines.

In another aspect, a method of making a collapsible beverage sleeve includes providing a blank comprising a single sheet of material having fold lines defining therebetween a plurality of adjacent side segments, and a base that is integrally connected at one of the fold lines to one of the side segments. The side segments include a first end segment, a plurality of interior segments, and a second end segment, one segment in the plurality of interior segments including an extension with a hinge portion. The method further includes folding the single sheet of material along the fold lines such that a beverage sleeve is formed; attaching the first end segment to the second end segment to form a surrounding side wall of the beverage sleeve; and attaching the extension to the base with the hinge portion extending between the base and the segment having the extension such that a bottom of the beverage sleeve is formed. The resulting beverage sleeve is transitionable between a use configuration and a collapsed configuration by concurrently folding along the fold lines without detaching the first and second end side segments and without detaching the extension and the base.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

FIG. 1 is a perspective view of a preferred embodiment of a collapsible, corrugated beverage sleeve in accordance with a preferred embodiment of the present invention, wherein the sleeve is assembled and in a configuration ready for use by insertion of a beverage container therein such as a can or bottle.

FIG. 2 is a view of the collapsible corrugated beverage sleeve of FIG. 1 in a disassembled configuration.

FIG. 3 is a perspective view of the collapsible, corrugated beverage sleeve of FIG. 1 representative of the transitioning of the sleeve between the assembled use configuration and an assembled collapsed configuration.

FIG. 4 is a perspective view of the collapsible, corrugated beverage sleeve of FIG. 1 in the assembled, collapsed configuration.

FIG. 5 is a photograph of a front view of a preferred embodiment of a collapsible corrugated beverage sleeve in an assembled use configuration in accordance with one or more preferred embodiments of the present invention.

FIG. 6 is a photograph of an alternate front view of the beverage sleeve of FIG. 5.

FIG. 6a is a photograph of another alternate front view of the beverage sleeve of FIG. 5.

FIG. 7 is a photograph of top view of the beverage sleeve of FIG. 5.

FIG. 8 is a photograph of a rear view of the beverage sleeve of FIG. 5, wherein overlapping end portions are attached together to form the cylinder shape of the beverage sleeve.

FIG. 9 is a photograph of a bottom view of the beverage sleeve of FIG. 5.

FIG. 10 is a photograph showing the bottom portion of the beverage sleeve of FIG. 5.

FIGS. 11 and 12 are photographs showing the bottom portion the beverage sleeve of FIG. 5 transitioning between the assembled use configuration and an assembled collapsed configuration.

FIG. 13 is a photograph of the beverage sleeve of FIG. 5 in the assembled, collapsed configuration.

FIGS. 14 and 15 are photographs of front and rear views, respectively, of another preferred embodiment of a collapsible corrugated beverage sleeve in an assembled use configuration in accordance with one or more preferred embodiments of the invention.

FIG. 16 is a photograph of the collapsible corrugated beverage sleeve of FIG. 14 in the assembled, collapsed configuration.

FIG. 17 is a photograph of a front view of another preferred embodiment of a collapsible corrugated beverage sleeve in an assembled use configuration in accordance with one or more preferred embodiments of the invention, wherein a beverage can has been received within the beverage sleeve in use of the beverage sleeve.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

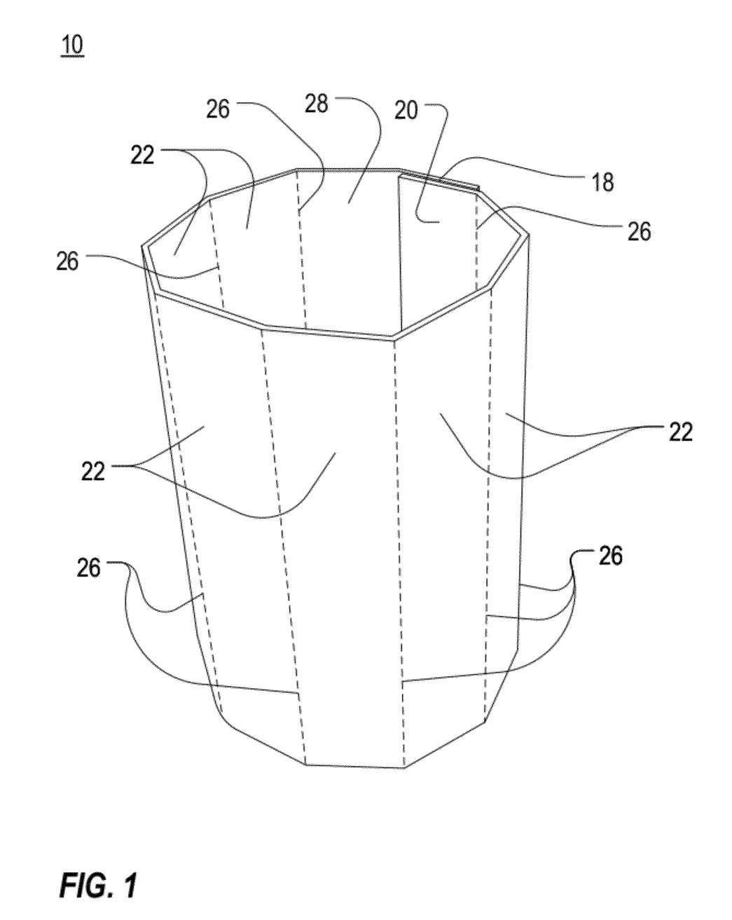

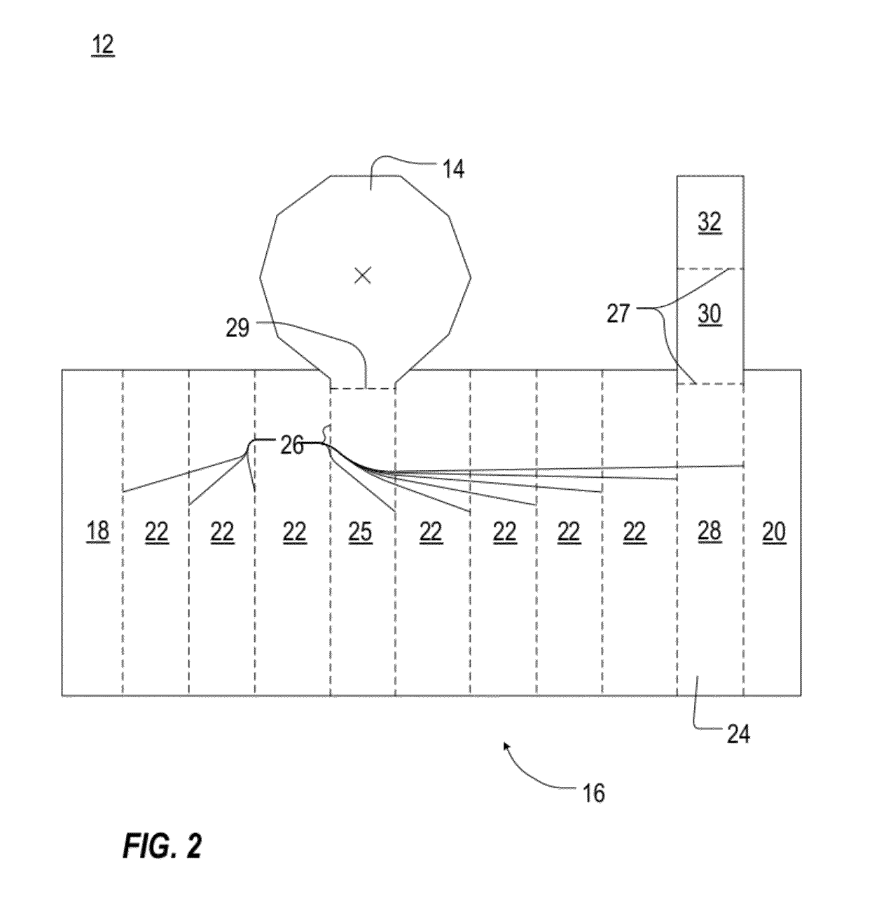

FIG. 1 is a perspective view of a preferred embodiment of a collapsible, corrugated beverage sleeve 10. The collapsible corrugated beverage sleeve 10 preferably is formed by folding and adhering together a single sheet of corrugated material 12, shown in FIG. 2. The single sheet of corrugated material 12 may be a ‘blank’ that results from a stamping or cutting process during manufacture, and may be cardboard.

FIG. 1 illustrates the single sheet of corrugated material after such assembly when the beverage sleeve is in a use configuration. In the use configuration, the beverage sleeve 10 is adapted to house a beverage container, in that the beverage sleeve is dimensioned and shaped to receive therein a beverage container such as a bottle or a can. The beverage sleeve 10 further acts as a barrier between the beverage container and a user's hand, providing temperature and moisture insulation to the user.

With further reference now to FIG. 2, the sheet of corrugated material 12 is shown in a flat, disassembled configuration. In one or more preferred embodiments, the sheet of corrugated material 12 comprises a base or bottom section 14 and a plurality of side sections 16. The plurality of side sections 16 comprises a first end side section 18, a second end side section 20, a plurality of standard length side sections 22, an extended length side section 24, and a shortened length side section 25. Each of the side sections in the plurality of side sections 16 is defined by one or more parallel fold lines 26 extending therebetween. Additionally, the extended length section 24 is subdivided by fold lines 27 into a side portion 28, a hinge portion 30, and a bottom attachment portion 32. The shortened length side section 25 is integrally connected via fold line 29 with the bottom section 14. As shown in FIG. 2, the fold lines 27 extend generally parallel to each other and orthogonally to the fold lines 26.

It will be appreciated from the following description that when the beverage sleeve 10 is assembled from the blank 12, the surface shown in FIG. 2 will become the interior surfaces of the beverage sleeve. Surfaces of the side sections 16 shown in FIG. 2 are therefore sometimes referred to as “interior” surfaces. Those surfaces opposite to the surfaces shown in FIG. 2 are sometimes referred to as exterior surfaces of the side sections.

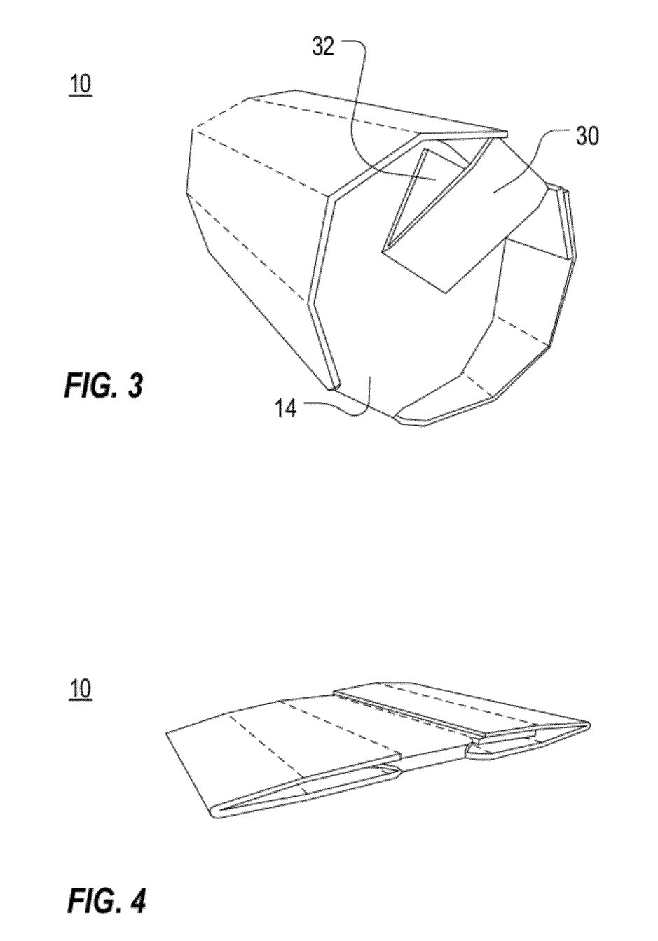

In assembling the beverage sleeve 10, the interior surface of the first end side section 18 is attached to the exterior surface of the second end side section 20. This attachment is accomplished using an adhesive such as glue, but other ways of attaching or securing the end side sections are contemplated within the present invention. Additionally, as perhaps best seen in FIG. 3, side section 24 is folded about fold lines 27 such the interior surface of the bottom attachment portion 32 faces the interior surface of the hinge portion 30, and the exterior surface of the bottom attachment portion 32 abuts the exterior surface of the bottom section 14, to which it is then attached. This attachment also is accomplished preferably using an adhesive such as glue, but other ways of attaching or securing the end side sections are contemplated within the present invention.

Once assembled, the beverage sleeve 10 is capable of transitioning between a use configuration, shown in FIG. 1, and a collapsed configuration, shown in FIG. 4. To transition the beverage sleeve 10, compressive forces are applied on exterior sides of side section 25 and side portion 28; and/or, a force is applied to the exterior surface of bottom 14, which singly or collectively cause the bottom section 14 to pivot about fold line 29 toward the interior of the beverage sleeve 10 and move, relative to side portion 28, via the hinge portion 30 interconnecting the bottom section 14 and side section 28. This movement in transitioning between these two assembled configurations is perhaps best represented in FIG. 3. In the collapsed configuration, half of the interior sides of the side section 16 forming the interior side surfaces of the beverage sleeve extend adjacent and in opposed facing relation to the other half of the interior sides of the side sections 16 forming the interior side surfaces of the sleeve.

In the use configuration, an interior space is created for receiving a beverage container. The volume of the interior space is defined by the plurality of side sections 16 and the bottom section 14. The volume of the interior space is generally maximized when the beverage sleeve 10 is in a use configuration and approximately equals the area of the bottom section 14 multiplied by the ‘height’ of the standard length side sections 22. When the beverage sleeve 10 is in a collapsed configuration, the volume of the interior space is practically eliminated, as shown in FIG. 4.

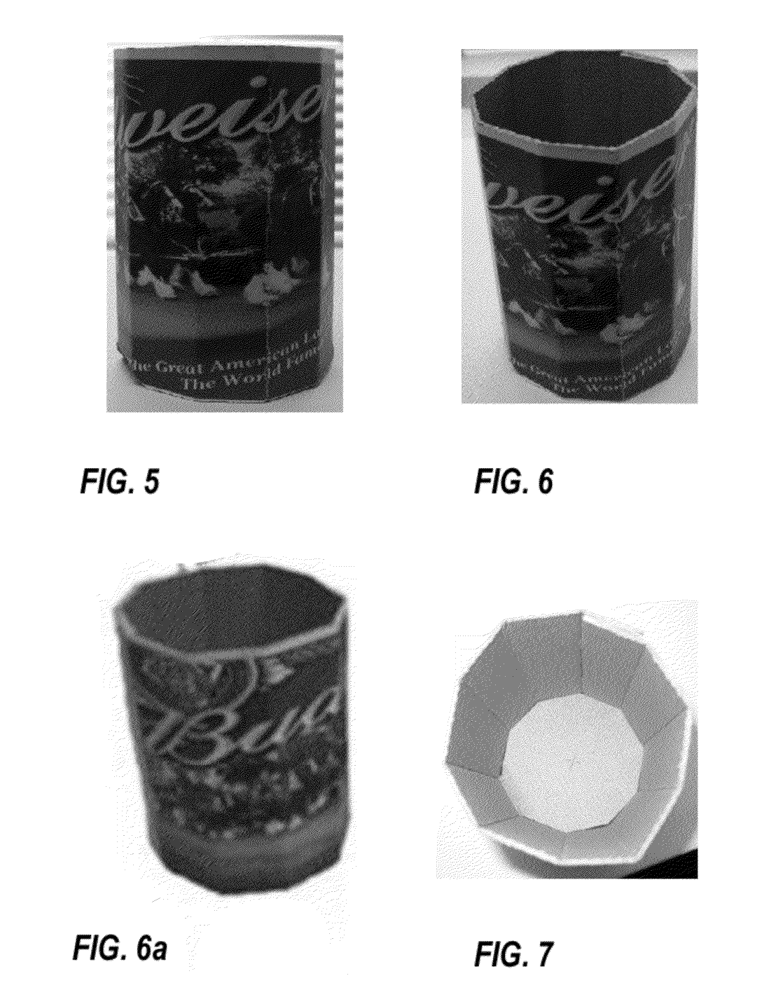

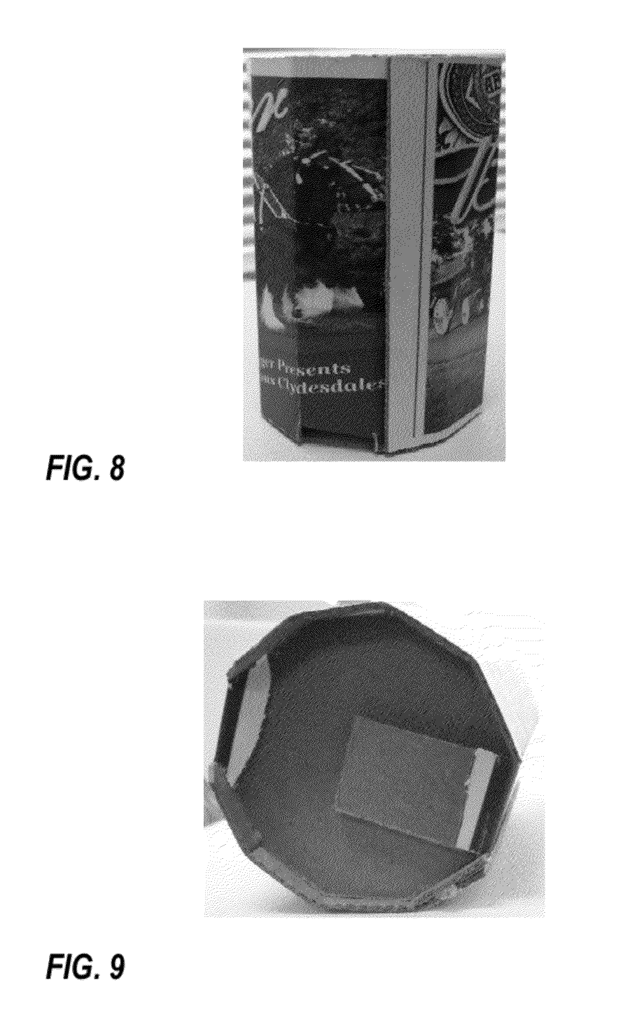

FIG. 5 is a photograph of a front view of a preferred embodiment of a collapsible corrugated beverage sleeve in a use configuration. FIGS. 6 and 6a are photographs of additional front views of the collapsible corrugated beverage sleeve of FIG. 5 in a use configuration. FIG. 7 is a photograph of a top view of the collapsible corrugated beverage sleeve of FIG. 5 in a use configuration. FIG. 8 is a photograph of a rear view of the collapsible corrugated beverage sleeve of FIG. 5 in a use configuration. FIG. 9 is a photograph of a bottom view of the collapsible corrugated beverage sleeve of FIG. 5 in a use configuration. As will be appreciated from FIG. 3 and FIG. 9, the bottom section generally provides a complete floor for the interior of the beverage sleeve with no openings or gaps. As such, the beverage sleeve is open on only one end, but not the other, and is usable as a container itself for articles, including pens, pencils, and other items.

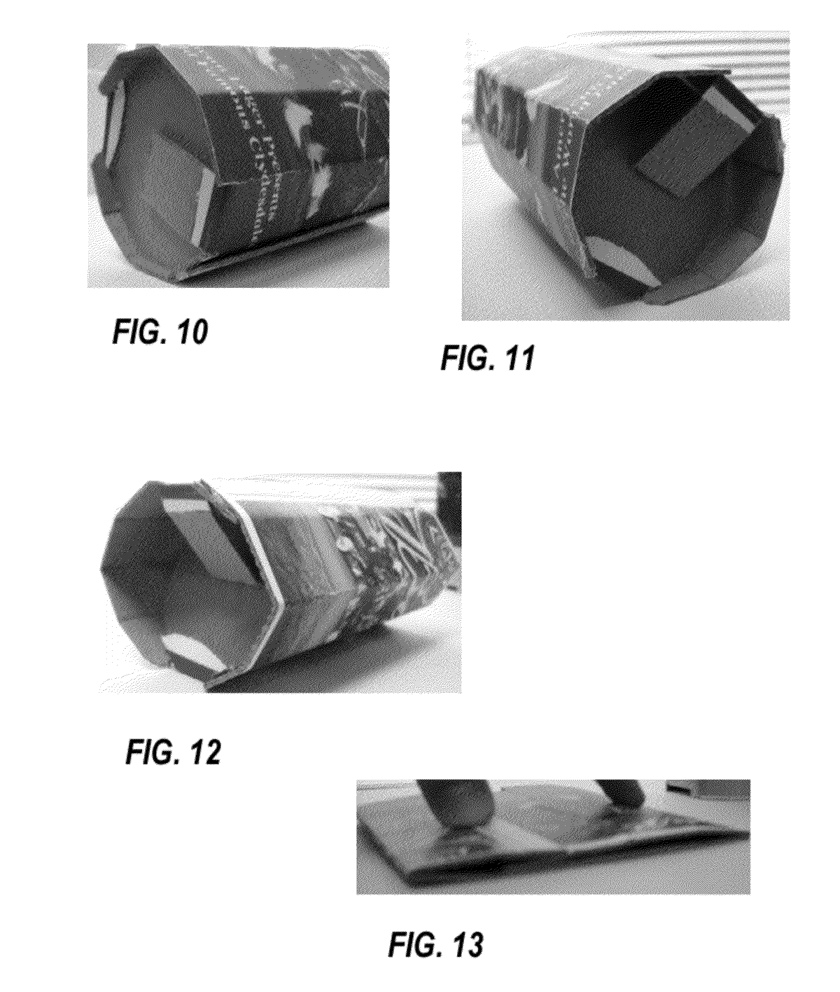

FIG. 10 is a photograph showing the bottom portion of the collapsible corrugated beverage sleeve of FIG. 5 in a use configuration. FIGS. 11 and 12 are photographs showing the bottom portion the collapsible corrugated beverage sleeve of FIG. 5 transitioning between the use configuration and the collapsed configuration. FIG. 13 is a photograph of the collapsible corrugated beverage sleeve of FIG. 5 in the collapsed configuration.

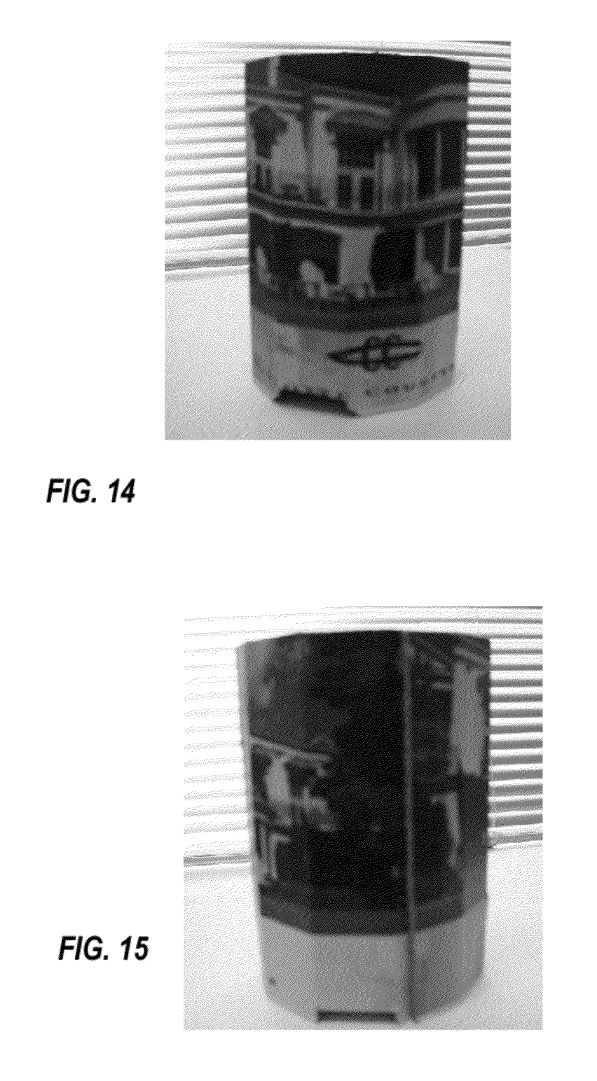

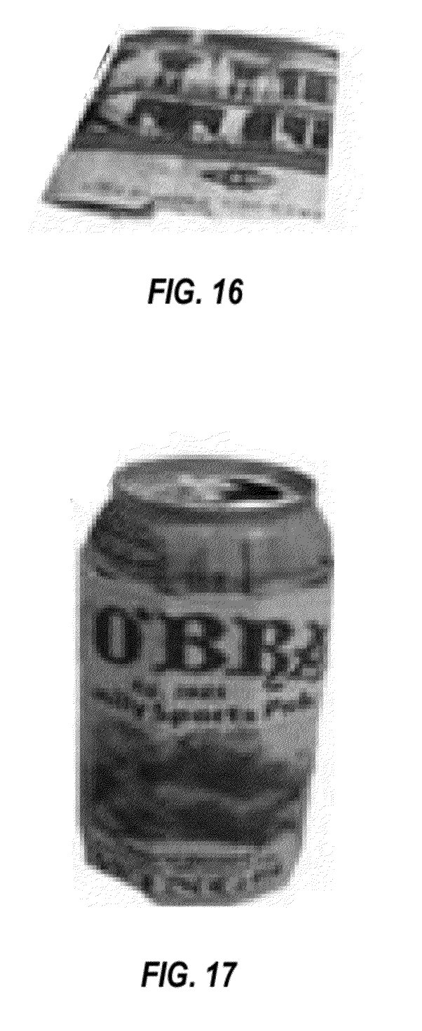

FIGS. 14 and 15 are photographs of an alternate embodiment of a collapsible corrugated beverage sleeve in the assembled, use configuration; and FIG. 16 is a photograph of this collapsible corrugated beverage sleeve in the assembled, collapsed configuration.

Finally, FIG. 17 is a photograph of a front view of another preferred embodiment of a collapsible corrugated beverage sleeve in an assembled, use configuration in accordance with one or more preferred embodiments of the invention, wherein a beverage can has been received within the beverage sleeve in actual use of the beverage sleeve.

As seen in the photographs of FIGS. 5-17, in one or more preferred embodiments, the beverage sleeve 10 includes a decorative element applied to the exterior surface of the sleeve. The decorative element can include advertising or promotional material, artistic or aesthetic embellishments, or other appropriate elements, and preferably is applied when or after the sheet of corrugated material 12 is made but before the sleeve 10 is assembled therefrom.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A blank for making a collapsible beverage sleeve comprising a single sheet of material, the single sheet comprising:
(a) a bottom section defining a bottom of the beverage sleeve when the blank is folded into a use configuration;
(b) a plurality of side sections defining sides of the beverage sleeve when the blank is a use configuration, the plurality of side sections being defined by one or more first fold lines extending therebetween and comprising,
(i) a first end side section,
(ii) a second end side section,
(iii) a plurality of standard length side sections,
(iv) an extended length side section subdivided by second fold lines into a side portion, a hinge portion, and a bottom attachment portion, the second fold lines extending generally parallel to each other and extending orthogonally to the first fold lines, and
(v) a shortened length side section integrally connected by way of a third fold line with the bottom section;
(c) wherein the bottom section and plurality of side sections are dimensioned and arranged such that the single sheet of material is foldable along with first fold lines, second fold lines, and third fold line into a use configuration of the beverage sleeve, with the first and second end side sections abutting one another, with the bottom attachment portion abutting the bottom section, and with the hinge portion extending between and interconnecting the bottom section and the side portion such that the beverage sleeve is transitionable between the use configuration and a collapsed configuration when the end side section are attached to one another and the bottom attachment portion is attached to the bottom section.

2. The blank for making a collapsible beverage sleeve of claim 1, wherein the single sheet of material comprises a generally planar sheet of corrugated material.

3. The blank for making a collapsible beverage sleeve of claim 1, wherein, in the use configuration, the collapsible beverage sleeve is adapted to house a beverage container.

4. The blank for making a collapsible beverage sleeve of claim 1, wherein, in the collapsed configuration, half of the interior sides of the side sections forming interior side surfaces of the beverage sleeve extend adjacent and in opposed facing relation to the other half of the interior sides of the side sections forming interior side surfaces of the beverage sleeve.

5. The blank for making a collapsible beverage sleeve of claim 1, further comprising a decorative element applied to an exterior surface of the single sheet of material.

6. The blank for making a collapsible beverage sleeve of claim 5, wherein the decorative element is adhered to a surface of the single sheet of material using adhesives.

7. The blank for making a collapsible beverage sleeve of claim 5, wherein the decorative element is printed directly on a surface of the single sheet of material.

8. The blank for making a collapsible beverage sleeve of claim 1, wherein a first side of the single sheet of material, when folded, defines the interior side surfaces of the beverage sleeve and the opposite, second side of the single sheet of material defines the exterior side surfaces of the beverage sleeve.

9. The blank for making a collapsible beverage sleeve of claim 1, wherein the first side of the single sheet of material when folded into the use configuration further defines the interior bottom surface of the beverage sleeve, and the opposite, seconds side of the single sheet of material defines the exterior bottom surface of the beverage sleeve.

10. A collapsible beverage sleeve comprising a single sheet of material, the single sheet comprising:
(a) a bottom section defining a bottom of the beverage sleeve;
(b) a plurality of side sections defining sides of the beverage sleeve, the plurality of side sections being defined by one or more first fold lines extending therebetween and comprising,
(i) a first end side section,
(ii) a second end side section,
(iii) a plurality of standard length side sections,
(iv) an extended length side section subdivided by second fold lines into a side portion, a hinge portion, and a bottom attachment portion, and
(v) a shortened length side section integrally connected by way of a third fold line with the bottom section;
(c) wherein with the first and second end side sections are attached to one another such that the plurality of side sections completely surrounds an interior space of the beverage sleeve;
(d) wherein the bottom attachment portion and bottom section are attached to one another, with the hinge portion extending between and interconnecting the bottom section and the side portion; and
(e) wherein the beverage sleeve is transitionable between a use configuration and a collapsed configuration by folding about the fold lines.

12. The collapsible beverage sleeve of claim 10, wherein the single sheet of material comprises a generally planar sheet of corrugated material.

13. The blank for making a collapsible beverage sleeve of claim 10, wherein, in the use configuration, the collapsible beverage sleeve is adapted to house a beverage container.

14. The blank for making a collapsible beverage sleeve of claim 10, wherein, in the collapsed configuration, half of the interior sides of the side sections forming interior side surfaces of the beverage sleeve extend adjacent and in opposed facing relation to the other half of the interior sides of the side sections forming interior side surfaces of the beverage sleeve.

15. The collapsible beverage sleeve of claim 10, further comprising a decorative element applied to an exterior surface of the single sheet of material.

16. The collapsible beverage sleeve of claim 15, wherein the decorative element is adhered to a surface of the single sheet of material using adhesives.

17. The collapsible beverage sleeve of claim 15, wherein the decorative element is printed directly on a surface of the single sheet of material.

18. The collapsible beverage sleeve of claim 10, wherein a first side of the single sheet of material, when folded, defines the interior side surfaces of the beverage sleeve and the opposite, second side of the single sheet of material defines the exterior side surfaces of the beverage sleeve.

19. The collapsible beverage sleeve of claim 10, wherein the first side of the single sheet of material when in the use configuration further defines the interior bottom surface of the beverage sleeve, and the opposite, seconds side of the single sheet of material defines the exterior bottom surface of the beverage sleeve.

20. A method of making a collapsible beverage sleeve, comprising the steps of:
(a) providing a blank comprising a single sheet of material having fold lines defining therebetween,
(i) a plurality of adjacent side segments, including a first end segment, a plurality of interior segments, and a second end segment, one segment in the plurality of interior segments including an extension with a hinge portion, and
(ii) a base that is integrally connected at one of the fold lines to one of the side segments;
(b) folding the single sheet of material along the fold lines such that a beverage sleeve is formed;
(c) attaching the first end segment to the second end segment to form a surrounding side wall of the beverage sleeve; and
(d) attaching the extension to the base with the hinge portion extending between the base and the segment having the extension such that a bottom of the beverage sleeve is formed;
(e) wherein the beverage sleeve is transitionable between a use configuration and a collapsed configuration by concurrently folding along the fold lines without detaching the first and second end side segments and without detaching the extension and the base.
